(19) United States
(12) Patent Application Publication
(10) Pub. No.: US 2012/0114225 A1
(43) Pub. Date: May 10, 2012

(54) IMAGE PROCESSING APPARATUS AND METHOD OF GENERATING A MULTI-VIEW IMAGE

(75) Inventors: Hwa Sup LIM, Hwaseong-si (KR); Seung Kyu Lee, Seoul (KR); Yong Sun Kim, Yongin-si (KR)

(73) Assignee: SAMSUNG ELECTRONICS CO., LTD., Suwon-si (KR)

(21) Appl. No.: 13/183,718

(22) Filed: Jul. 15, 2011

(30) Foreign Application Priority Data
Nov. 9, 2010 (KR) 10-2010-0110994

(51) Int. Cl. G06K 9/00

(52) U.S. Cl. 382/154

(57) ABSTRACT

An image processing apparatus may detect an occlusion boundary between objects within an input depth image by applying an edge detection algorithm to the input depth image. The image processing apparatus may classify the occlusion boundary into a foreground region boundary and a background region boundary using a depth gradient vector direction of the occlusion boundary, and may extract an occlusion region of the input depth image using the foreground region boundary.

### CROSS-REFERENCE TO RELATED APPLICATIONS

This application claims the priority benefit of Korean Patent Application No. 10-2010-0110994, filed on Nov. 9, 2010, in the Korean Intellectual Property Office, the disclosure of which is incorporated herein by reference.

### BACKGROUND

1. Field

Example embodiments relate to an apparatus and method of generating a multi-view image to provide a three-dimensional (3D) image, and more particularly, to an image processing apparatus and method that may detect an occlusion region according to a difference between viewpoints, and generate a multi-view image using the detected occlusion region.

The example embodiments are related to the National Project Research supported by the Ministry of Knowledge Economy [Project NO.: 10037931] entitled The development of active sensor-based HD (High Definition)-level 3D (three-dimensional) depth camera.

2. Description of the Related Art

Currently, interest in three-dimensional (3D) images is increasing. A 3D image may be configured by providing images corresponding to different viewpoints with respect to a plurality of viewpoints. The 3D image may include, for example, a multi-view image corresponding to the plurality of viewpoints, or a stereoscopic image providing a left eye image and a right eye image corresponding to two viewpoints.

When each view image corresponding to the multi-view image or the stereoscopic image is photographed at a single viewpoint instead of being directly photographed and then, another view image is generated through an image processing process, detecting of an occlusion region between objects and restoring color information of the occlusion region may become difficult.

Accordingly, there is a desire for an image processing method that may appropriately detect an occlusion region dis-occluded according to image warping and may obtain color information of the occlusion region.

### SUMMARY

The foregoing and/or other aspects are achieved by providing an image processing apparatus, including at least one processing device to execute an occlusion boundary detector to detect an occlusion boundary between objects within an input depth image by applying an edge detection algorithm to the input depth image, an occlusion boundary labeling unit to classify the occlusion boundary into a foreground region boundary and a background region boundary using a depth gradient vector direction of the occlusion boundary and a region identifier to extract an occlusion region of the input depth image using the foreground region boundary.

The image processing apparatus may further include an occlusion layer generator to restore a depth value of the occlusion region using a depth value of a region excluding the occlusion region in the input depth image.

The occlusion layer generator may restore a color value of the occlusion region using at least a pixel value of an input color image matched with the input depth image.

The occlusion layer generator may restore the color value of the occlusion region using the at least a pixel value of the input color image matched with the input depth image, by employing at least one of an inpainting algorithm of a patch copy scheme and an inpainting algorithm of a partial differential equation (PDE) scheme. The edge detection algorithm may correspond to a Canny edge detection algorithm.

The occlusion boundary labeling unit may classify the occlusion region into the foreground region boundary and the background region boundary by determining, as the foreground region boundary, a pixel adjacent to a depth gradient vector direction with an increasing depth value among occlusion boundary pixels, and by determining, as the background region boundary, a pixel adjacent to a direction opposite to the depth gradient vector direction.

The region identifier may extract the occlusion region of the input depth image by employing a region expansion using the foreground region boundary as a seed, and a segmentation algorithm.

The segmentation algorithm may correspond to at least one of a watershed algorithm and a graphcut algorithm.

The image processing apparatus may further include a multi-view image generator to generate at least one of a depth image and a color image with respect to each of at least one change viewpoint different from a viewpoint of the input depth image, based on a depth value and a color value of the occlusion region.

The multi-view image generator may generate at least one of the depth image and the color image with respect to the at least one change viewpoint by warping the input color image and the input color image to correspond to the at least one change viewpoint, by filling the occlusion region using the color value of the occlusion region, and by performing a hole filling algorithm.

The foregoing and/or other aspects are achieved by providing an image processing method, including detecting, by at least one processing device, an occlusion boundary between objects within an input depth image by applying an edge detection algorithm to the input depth image, classifying, by the at least one processing device, the occlusion boundary into a foreground region boundary and a background region boundary using a depth gradient vector direction of the occlusion boundary and extracting, by the at least one processing device, an occlusion region of the input depth image using the foreground region boundary.

According to another aspect of one or more embodiments, there is provided at least one non-transitory computer readable medium including computer readable instructions that control at least one processor to implement methods of one or more embodiments.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates an image processing apparatus according to example embodiments;

FIG. 2 illustrates a color image and a depth image input into the image processing apparatus of FIG. 1 according to example embodiments;

FIG. 3 illustrates a detection result of an occlusion region boundary according to example embodiments;

FIG. 4 illustrates a classification result of a foreground region boundary and a background region boundary according to example embodiments;

FIG. 5 illustrates a classification result of an occlusion region according to example embodiments;

FIG. 6 illustrates a restoration result of a color value of an occlusion region layer using an input color image according to example embodiments;

FIG. 7 illustrates a diagram of a process of generating a change view image according to example embodiments;

FIG. 8 illustrates a generation result of a plurality of change view images according to example embodiments; and

FIG. 9 illustrates an image processing method according to example embodiments.

### DETAILED DESCRIPTION

Reference will now be made to embodiments, examples of which are illustrated in the accompanying drawings, wherein like reference numerals refer to like elements throughout. Embodiments are described below to explain the present disclosure by referring to the figures.

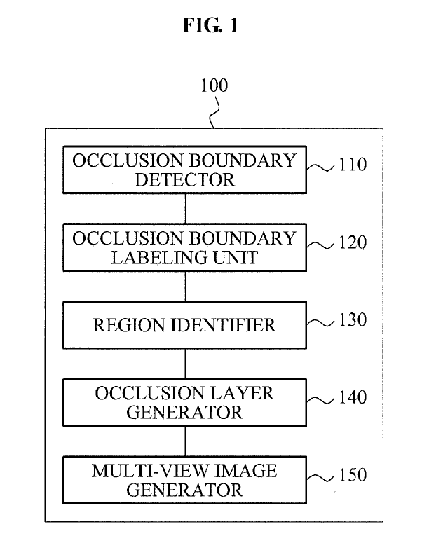

FIG. 1 illustrates an image processing apparatus 100 according to example embodiments.

An occlusion boundary detector 110 may detect an occlusion boundary within an input depth image by applying an edge detection algorithm to the input depth image.

The occlusion boundary detector 110 may employ a variety of schemes for detecting a continuous edge, for example, a Canny edge detection algorithm and the like. However, this is only an example.

The occlusion boundary corresponds to a portion for separating a region determined as an occlusion region and a remaining region, and may be a band having a predetermined width, instead of a unit pixel line. For example, a portion may be classified as the occlusion boundary that may not clearly belong to the occlusion region and the remaining region.

A process of detecting the occlusion region by the occlusion boundary detector 110 will be further described with reference to FIG. 3.

An occlusion boundary labeling unit 120 may classify the occlusion boundary into a foreground region boundary adjacent to a foreground region and a background region boundary adjacent to a background region, based on a depth gradient vector direction of the occlusion boundary, and thereby separately label the foreground region boundary and the background region boundary.

In this example, the occlusion boundary labeling unit 120 may classify the occlusion boundary into a foreground boundary and a background boundary based on a depth gradient vector direction in an adjacent pixel of the occlusion boundary. An adjacent pixel of the depth gradient vector direction, for example, in a direction with an increasing depth value may correspond to the foreground boundary. An adjacent pixel in an opposite direction may correspond to the background boundary.

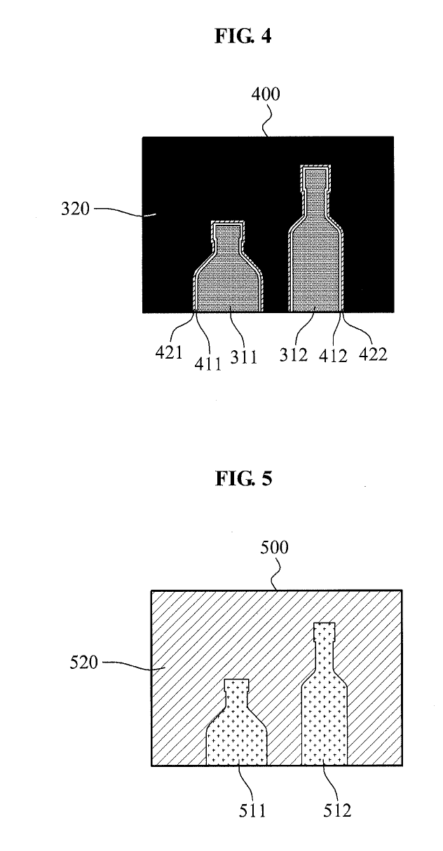

A process of separately labeling the foreground region boundary and the background region boundary using the occlusion boundary labeling unit 120 will be further described with respect to FIG. 4.

A region identifier 130 may extract the occlusion region in the input depth image using the foreground region boundary. The above occlusion region extraction process may be understood as a region segmentation process of identifying the background region and the foreground region in the input depth image.

For example, in a depth image or a color image, a foreground region may partially occlude a background region. An occluded portion may be partially dis-occluded during a warping process because of a viewpoint movement and thus, the occlusion region may correspond to the foreground region.

A process of extracting the occlusion region by the region identifier 130 will be further described with reference to FIG. 5.

An occlusion layer generator 140 may restore a depth value of the occlusion region using a depth value of a region excluding the occlusion region in the input depth image.

The occlusion layer generator 140 may restore a color value of the occlusion region using at least a pixel value of an input color image matched with the input depth image.

The restored color value of the occlusion region will be further described with reference to FIG. 6.

When an image of a change viewpoint different from a viewpoint of the input depth image and/or the input color image is to be generated, a multi-view image generator 150 may generate the above change view image.

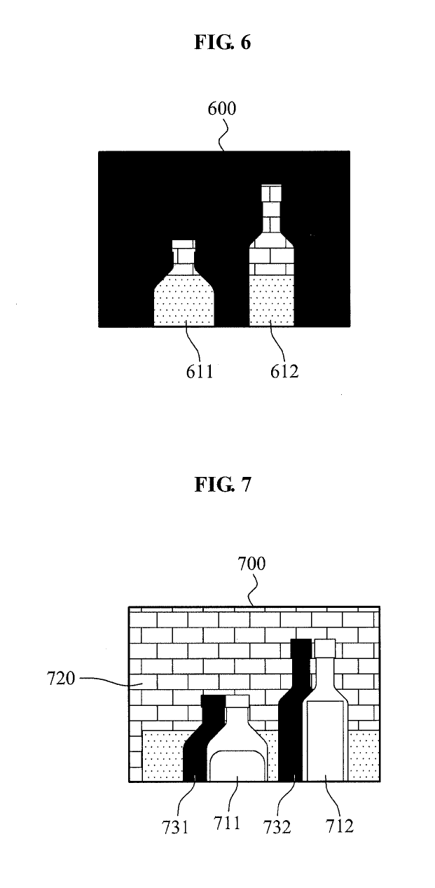

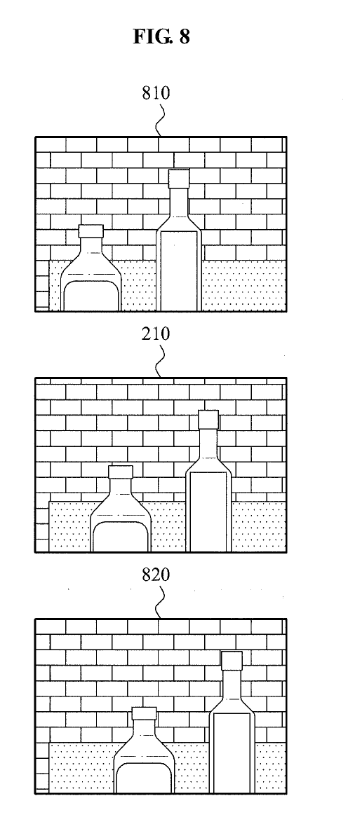

An image warping process for view change and a multi-view image will be further described with reference to FIG. 7 and FIG. 8.

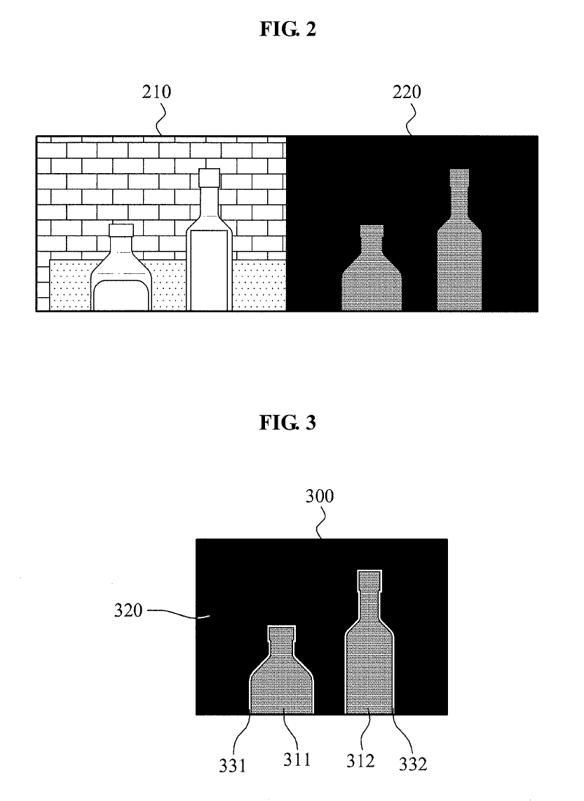

FIG. 2 illustrates a color image 210 and a depth image 220 input into the image processing apparatus 100 of FIG. 1 according to example embodiments.

The color image 210 and the depth image 220 may be acquired at the same time and at different viewpoints. Viewpoints and scales of the input color image 210 and the input depth image 220 may be matched with each other.

Matching of the input color image 210 and the input depth image 220 may be performed by acquiring a color image and a depth image at the same time and at different viewpoints using the same camera sensor, and may be performed by matching a color image and a depth image photographed at different viewpoints using different sensors during an image processing process.

Hereinafter, the input color image 210 and the input depth image 220 may be assumed to be matched with each other based on a viewpoint and a scale.

FIG. 3 illustrates a detection result 300 of an occlusion region boundary according to example embodiments.

The occlusion boundary detector 110 of the image processing apparatus 100 may detect an occlusion boundary within the input depth image 220 of FIG. 2 by applying an edge detection algorithm to the input depth image 220.

The occlusion boundary detector 110 may employ a variety of schemes for detecting a continuous edge, for example, a Canny edge detection algorithm. However, this is only an example.

Within the input depth image 220, a discontinuous depth value between adjacent pixels may correspond to a boundary of the occlusion region when a viewpoint changes. Accordingly, the occlusion boundary detector 110 may detect occlusion boundaries 331 and 332 by applying the edge detection algorithm to the input depth image 220.

The input depth image 220 may be separated into at least two regions by the detected occlusion boundaries 331 and 332.

The input depth image 220 may be classified into foreground regions 311 and 312, and a background region 320 based on a depth value. The above process may be performed by a process to be described with reference to FIG. 4.

FIG. 4 illustrates a classification result 400 of a foreground region boundary and a background region boundary according to example embodiments.

The occlusion boundary labeling unit 120 may classify the occlusion boundary into foreground region boundaries 411 and 412 adjacent to a foreground region and background region boundaries 421 and 422 adjacent to the background region 320, based on a depth gradient direction of the occlusion boundary, and thereby separately label the foreground region boundaries 411 and 412 and the background region boundaries 421 and 422.

In this example, the occlusion boundary labeling unit 120 may classify the occlusion boundary into a foreground boundary and a background boundary based on a depth gradient vector direction in an adjacent pixel of the occlusion boundary. Adjacent pixels of the depth gradient vector direction, for example, in a direction with an increasing depth value may correspond to the foreground boundary. Adjacent pixels in an opposite direction may correspond to the background boundary.

FIG. 5 illustrates a classification result 500 of an occlusion region according to example embodiments.

The region identifier 130 may extract occlusion regions 511 and 512 in the input depth image 220, using the foreground region boundaries 411 and 412 of FIG. 4. The above occlusion region extraction process may be understood as a region segmentation process for identifying the background region and the foreground region in the input depth image.

According to example embodiments, the region identifier 130 may perform region segmentation expanding a region by employing the foreground region boundaries 411 and 412 as a seed, determining the foreground regions 511 and 512, and expanding a region by employing the background region boundaries 421 and 422 as a seed, and determining a background region 520.

An example of the foreground regions 511 and 512 extracted as the occlusion regions is described above with reference to FIG. 1.

During the above segmentation process, the region identifier 130 may use various types of segmentation algorithms, for example, a watershed algorithm, a graphcut algorithm, and the like.

FIG. 6 illustrates a restoration result 600 of a color value of an occlusion region layer using an input color image according to example embodiments.

The occlusion layer generator 140 may restore depth values of the foreground regions 511 and 512 that are the occlusion regions, based on a depth value of the background region 520 that is a remaining region excluding the occlusion region in the input depth image 220. Here, horizontal copy and expansion of the depth value may be used.

The occlusion layer generator 140 may restore a color value of the occlusion region using at least a pixel value of the input color image 210 matched with the input depth image 220. Regions 611 and 612 may correspond to the occlusion layer restoration results.

In many cases, an occlusion region may be in a background region behind a foreground region. A dis-occlusion process of the occlusion region according to a change in a viewpoint may horizontally occur. Accordingly, an occlusion layer may be configured by continuing a boundary of the background region and copying the horizontal pattern similar to the background region.

During the above process, the occlusion layer generator 140 may employ a variety of algorithms, for example, an inpainting algorithm of a patch copy scheme, an inpainting algorithm of a partial differential equation (PDE) scheme, and the like. However, these are only examples.

FIG. 7 illustrates a diagram 700 according to a process of generating a change view image according to example embodiments.

When an image of a change viewpoint different from a viewpoint of the input depth image and/or the input color image is to be generated, the multi-view image generator 150 may generate the above change view image.

The above change view image may be a single view image different from the input color image 210 or the input depth image 220 between two viewpoints of a stereoscopic scheme, and may also be a view image different from a multi-view image.

The multi-view image generator 150 may horizontally warp depth pixels and color pixels corresponding to occlusion regions 711 and 712 using an image warping scheme.

In the above process, a degree of warping may be great according to an increase in a viewpoint difference, which may be readily understood by a general disparity calculation. A background region 720 may have a relatively small disparity. According to the example embodiments, a disparity may be ignored if image warping of the background region 720 may be significantly small.

The multi-view image generator 150 may fill, using the occlusion layer restoration results 611 and 612 of FIG. 6, existing occlusion region portions 731 and 732 remaining as holes after the image warping between the input color image 210 and the input depth image 220.

In the above process, a hole occurring because of minute image mismatching may be simply solved using a hole filling algorithm and the like including a general image processing scheme.

FIG. 8 illustrates a generation result of a plurality of change view images according to example embodiments.

FIG. 8 illustrates a result 810 of performing the above process of FIG. 7 based on a first change viewpoint that is a left viewpoint of a reference viewpoint corresponding to the input color image 210 and the input depth image 220, and a result 820 of performing the above process based on a second change viewpoint that is a right viewpoint of the reference viewpoint.

When a change view image is generated and provided at a predetermined position according to the aforementioned scheme, the multi-view image may be generated.

According to the example embodiments, when generating a change view image, it is possible to quickly and accurately generate a relatively large number of multi-view images by scaling a depth value of a single depth image.

According to the example embodiments, because an occlusion layer to be commonly used is generated, there is no need to restore an occlusion region at every viewpoint. Because the same occlusion layer is used, the restored occlusion region may have a consistency. Accordingly, it is possible to significantly decrease artifacts, for example, ghost effect and the like occurring when generating a multi-view 3D image.

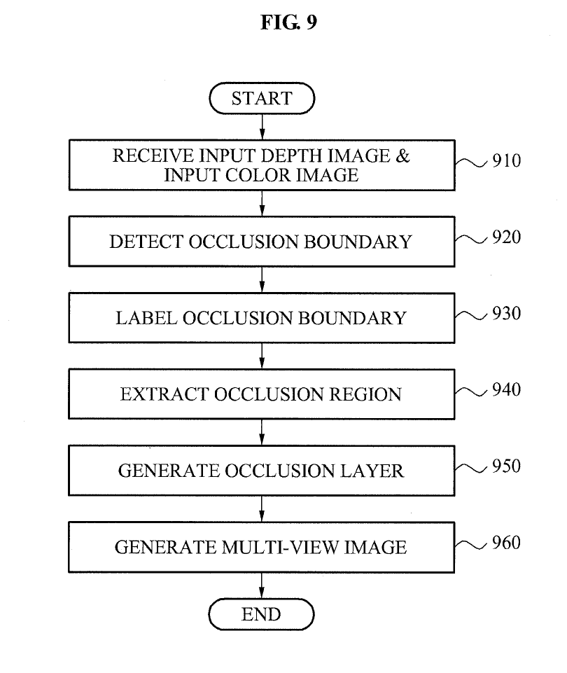

FIG. 9 illustrates an image processing method generating a multi-view image according to example embodiments.

In 910, an input color image and an input depth image may be input.

In 920, the occlusion boundary detector 110 of the image processing apparatus 100 may detect an occlusion boundary within the input depth image by applying an edge detection algorithm to the input depth image.

A process of detecting the occlusion boundary by the occlusion boundary detector 110 in 920 is described above with reference to FIG. 3.

In 930, the occlusion boundary labeling unit 120 may classify the occlusion boundary into a foreground region boundary adjacent to a foreground region and a background region boundary adjacent to a background region, based on a depth gradient vector direction of the occlusion boundary, and thereby separately label the foreground region boundary and the background region boundary.

A process of separately labeling the foreground region boundary and the background region boundary by the occlusion boundary labeling unit 120 in 930 is described above with reference to FIG. 4.

In 940, the region identifier 130 may extract the occlusion region in the input depth image using the foreground region boundary.

The above occlusion region extraction process may be understood as a region segmentation process of identifying the background region and the foreground region in the input depth image, and is described above with reference to FIG. 5.

In 950, the occlusion layer generator 140 may restore a depth value of the occlusion region using a depth value of a region excluding the occlusion region in the input depth image, which is described above with reference to FIG. 6.

In 960, when an image of a change viewpoint different from a viewpoint of the input depth image and/or the input color image is to be generated, the multi-view image generator 150 may generate the above change view image.

The image warping process for the view change and a multi-view image generated through this process are described above with reference to FIG. 7 and FIG. 8.

The above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it should be appreciated by those skilled in the art that changes may be made in these embodiments without departing from the principles and spirit of the disclosure, the scope of which is defined by the claims and their equivalents.

What is claimed is:

1. An image processing apparatus, comprising:
at least one processing device to execute:
an occlusion boundary detector to detect an occlusion boundary between objects within an input depth image by applying an edge detection algorithm to the input depth image;
an occlusion boundary labeling unit to classify the occlusion boundary into a foreground region boundary and a background region boundary using a depth gradient vector direction of the occlusion boundary; and
a region identifier to extract an occlusion region of the input depth image using the foreground region boundary.

2. The image processing apparatus of claim 1, further comprising:
an occlusion layer generator to restore a depth value of the occlusion region using a depth value of a region excluding the occlusion region in the input depth image.

3. The image processing apparatus of claim 2, wherein the occlusion layer generator restores a color value of the occlusion region using at least one pixel value of an input color image matched with the input depth image.

4. The image processing apparatus of claim 3, wherein the occlusion layer generator restores the color value of the occlusion region using the at least one pixel value of the input color image matched with the input depth image, by employing at least one of an inpainting algorithm of a patch copy scheme and an inpainting algorithm of a partial differential equation (PDE) scheme.

5. The image processing apparatus of claim 1, wherein the edge detection algorithm corresponds to a Canny edge detection algorithm.

6. The image processing apparatus of claim 1, wherein the occlusion boundary labeling unit classifies the occlusion region into the foreground region boundary and the background region boundary by determining, as the foreground region boundary, a pixel adjacent to a depth gradient vector direction with an increasing depth value among occlusion boundary pixels, and by determining, as the background region boundary, a pixel adjacent to a direction opposite to the depth gradient vector direction.

7. The image processing apparatus of claim 1, wherein the region identifier extracts the occlusion region of the input depth image by employing a region expansion using the foreground region boundary as a seed, and a segmentation algorithm.

8. The image processing apparatus of claim 7, wherein the segmentation algorithm corresponds to at least one of a watershed algorithm and a graphcut algorithm.

9. The image processing apparatus of claim 3, further comprising:
a multi-view image generator to generate at least one of a depth image and a color image with respect to each of at least one change viewpoint different from a viewpoint of the input depth image, based on a depth value and a color value of the occlusion region.

10. The image processing apparatus of claim 9, wherein the multi-view image generator generates at least one of the depth image and the color image with respect to the at least one change viewpoint by warping the input color image and the input color image to correspond to the at least one change viewpoint, by filling the occlusion region using the color value of the occlusion region, and by performing a hole filling algorithm.

11. An image processing method, comprising:
detecting, by at least one processing device, an occlusion boundary between objects within an input depth image by applying an edge detection algorithm to the input depth image;
classifying, by the at least one processing device, the occlusion boundary into a foreground region boundary and a background region boundary using a depth gradient vector direction of the occlusion boundary; and
extracting, by the at least one processing device, an occlusion region of the input depth image using the foreground region boundary.

12. The image processing method of claim 11, further comprising:
restoring a depth value of the occlusion region using a depth value of a region excluding the occlusion region in the input depth image.

13. The image processing method of claim 12, wherein the restoring comprises restoring a color value of the occlusion region using at least a pixel value of an input color image matched with the input depth image.

14. The image processing method of claim 11, wherein the identifying comprises:
determining, as the foreground region boundary, a pixel adjacent to a depth gradient vector direction with an increasing depth value among occlusion boundary pixels;
determining, as the background region boundary, a pixel adjacent to a direction opposite to the depth gradient vector direction; and
classifying the occlusion region into the foreground region boundary and the background region boundary.

15. The image processing method of claim 11, wherein the extracting comprises extracting the occlusion region of the input depth image by employing a region expansion using the foreground region boundary as a seed, and a segmentation algorithm.

16. The image processing method of claim 13, further comprising:
generating at least one of a depth image and a color image with respect to each of at least one change viewpoint different from a viewpoint of the input depth image, based on a depth value and a color value of the occlusion region.

17. The image processing method of claim 16, wherein the generating comprises:
warping the input color image and the input color image to correspond to the at least one change viewpoint;
filling the occlusion region using the color value of the occlusion region; and
generating at least one of the depth image and the color image with respect to the at least one change viewpoint by performing a hole filling algorithm with respect to a filling result of the occlusion region.

18. At least one non-transitory computer-readable medium comprising computer readable instructions that control at least one processing device to implement the method of claim 11.
